(19) United States
(12) Patent Application Publication
(10) Pub. No.: US 2005/0073943 A1
(43) Pub. Date: Apr. 7, 2005

(54) Optical recording medium and method of manufacturing the same

(75) Inventors: Seiro Oshima, Koufu-shi (JP); Toshihiko Takishita, Koufu-shi (JP); Atsushi Kondo, Koufu-shi (JP); Kazuo Kuroda, Tokorozawa-shi (JP); Toshio Suzuki, Tokorozawa-shi (JP); Eiji Muramatsu, Tokorozawa-shi (JP); Masahiro Kato, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/949,566

(22) Filed: Sep. 27, 2004

(30) Foreign Application Priority Data
Oct. 3, 2003 (JP) P2003-345786

(51) Int. Cl. G11B 7/24

(52) U.S. Cl. 369/286; 369/288

(57) ABSTRACT

An optical recording medium is provided which can solve a problem of insufficient signal amplitude of one recording layer as compared with the other recording layer in a writable optical recording medium of a conventional double layer structure. An optical recording medium, in which a first substrate having a first groove formed thereon, a first recording layer formed on a first-groove forming surface of the first substrate, a semi-translucent first reflecting layer, an intermediate layer, a second recording layer, a second reflecting layer, and a second substrate having a second groove formed thereon are at least disposed in this order, wherein the optical recording medium further includes a heat conducting layer between the second recording layer and the intermediate layer and a heat insulating layer between the second recording layer and the second reflecting layer.

### BACKGROUND OF THE INVENTION

1. Field of the Invention

The present invention relates to an optical recording medium and a method of manufacturing the same. More particularly, the present invention relates to a writable optical recording medium of a double layer structure and a method of manufacturing the same.

2. Description of the Related Art

Optical recording mediums such as a DVD (digital versatile disc) are conventionally known as recording mediums for recording and reproducing various kinds of information. The known optical recording mediums include an optical recording medium of single layer type which has a layer for recording information from one side, and an optical recording medium of dual layer type which has two layers for recording information from one side.

Of these optical recording mediums, the optical recording medium of dual layer type has two layers for recording information (hereinafter simply referred to as recording layers), so that a large amount of information can be recorded and reproduced with high density. Further, since the optical recording medium of dual layer type makes it possible to record information on two recording layers from one side, it is not necessary to provide and switch optical pickups on the respective sides of the optical recording medium in a recording/reproducing apparatus for the optical recording medium. Moreover, the optical recording medium of dual layer type does not have to flip the optical recording medium during recording and reproduction. Thus, the optical recording medium of dual layer type enables so-called seamless recording and seamless reproduction.

As described above, the optical recording medium of dual layer type is advantageous in that it has superior functionarity for recording information, a recording/reproducing apparatus can have a simple configuration, and seamless recording and reproduction do not interrupt with the user who watches videos.

Regarding such DVDs, so-called DVD-R and DVD-RAM have been already developed which enable the user to record information.

Of these DVDs, a DVD-R has a basic configuration in which a pregroove of a spiral groove serving as the tracking device of an optical pickup is formed in an information recording region on a surface of a disc, on which a recording medium made of a material such as an organic dye is applied by spin coating and so on, and dried to form a recording layer, and a reflecting layer composed of a metal film is formed thereon.

For example, as shown in FIG. 1, Japanese Patent Laid-Open No. 11-66622 discloses an optical recording medium 10 as a DVD-R optical recording medium of dual layer type. In the optical recording medium 10, a first disc and a second disc are bonded to each other using an adhesive 4B and so on with a first reflecting layer 31B and a second recording layer 22B facing each other. The first disc is composed of a first substrate 11B, a first recording layer 21B made of an organic dye, and the semi-translucent first reflecting layer 31B, and the second disc is composed of a second substrate 12B, a second reflecting layer 32B, and a second recording layer 22B. In the optical recording medium 10, a laser beam is applied from the side of the first substrate 11B to record information in the recording layers 21B and 22B.

As is evident from FIG. 1, in the dual-layer type optical recording medium having both sides bonded to each other, a first groove G1B is formed on the first substrate 11B, and the first recording layer 21B and the first reflecting layer 31B are laminated in this order on a surface of the first substrate 11B, the first groove G1B being formed on the surface thereof. Meanwhile, a second groove G2B is formed on the second substrate 12B, and the second reflecting layer 32B and the second recording layer 22B are laminated in this order on a surface of the second substrate 12B, the second groove G2B being formed on the surface thereof. Therefore, a contact area between the second recording layer 22B and the second reflecting layer 32B is larger than a contact area between the first recording layer 21B and the first reflecting layer 31B.

In this case, when a laser beam is applied from the side of the first substrate 11B of the optical recording medium 10 to record information in the first recording layer 21B in the first groove G1B and the second recording layer 22B in the second groove G2B, a thermal behavior different between the first recording layer 21B in the first groove G1B and the second recording layer 22B in the second groove G2B. Thus, recording cannot be performed on the recording layers under the same conditions. To be specific, the second recording layer 22B in the second groove G2B is less prone to thermal deformation caused by a laser beam. Thus, when information is recorded in each groove by using a laser beam of a constant energy, the second groove G2B may not obtain a sufficient signal amplitude.

Comparing the hardness of the first substrate 11B making contact with the first groove G1B and the hardness of the second reflecting layer 32B making contact with the second groove G2B, the second reflecting layer 32B is harder in ordinary cases. Hence, a laser beam is less likely to cause thermal deformation around a boundary surface of the second reflecting layer 32B. Consequently, as in the foregoing case, the second groove G2B may not obtain a sufficient signal amplitude as compared with the first groove G1B.

The present invention is devised in view of the circumstances. An example of an object of the present invention is to provide an optical recording medium which can solve the problem of the conventional writable optical recording medium of a double layer structure, in which one recording layer cannot obtain a sufficient signal amplitude as compared with the other. Another example of the object of the present invention is to provide a method for readily manufacturing the optical recording medium.

### SUMMARY OF THE INVENTION

A mean for solving the problem according to claim 1 is an optical recording medium, in which a first substrate having a first groove formed thereon, a first recording layer formed on a first-groove forming surface of the first substrate, a semi-translucent first reflecting layer, an intermediate layer, a second recording layer, a second reflecting layer, and a second substrate having a second groove formed thereon are at least disposed in this order from the side where a laser beam for recording, reproduction, or recording/reproduction is applied, the optical recording medium further comprising a heat conducting layer between the second recording layer and the intermediate layer and a heat insulating layer between the second recording layer and the second reflecting layer.

A mean for solving the problem according to claim 3 is a method of manufacturing an optical recording medium, the method comprising the steps of: laminating a first recording layer made of a dye material and a semi-translucent first reflecting layer in this order on a first-groove forming surface of a first substrate, laminating a second reflecting layer, a heat insulating layer, a second recording layer made of a dye material, and a heat conducting layer in this order on a second-groove forming surface of a second substrate, and bonding the first and second substrates on which the above-mentioned layers are laminated, respectively, to each other via a transparent intermediate layer with the first reflecting layer and the heat conducting layer facing each other.

### BRIEF DESCRIPTION OF THE DRAWINGS

FIG. 1 is a sectional view showing an optical recording medium of the conventional art; and

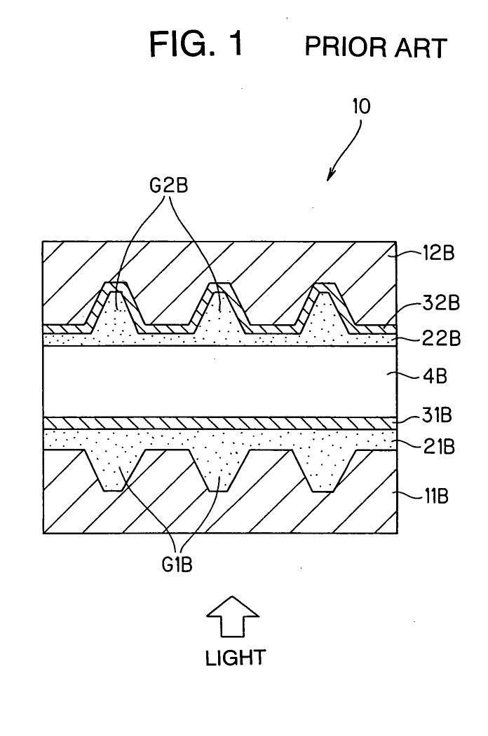

FIG. 2 is a sectional view showing an optical recording medium according to an embodiment of the present invention.

### DETAILED DESCRIPTION OF THE PREFERRED EMBODIMENTS

An optical recording medium of the present invention will be specifically described below in accordance with the accompanying drawings.

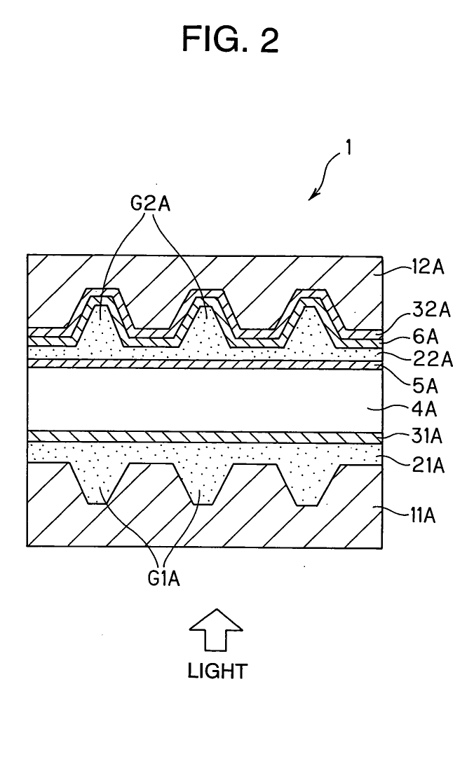

FIG. 2 is a sectional view which partially shows the optical recording medium along the thickness direction according to an embodiment of the present invention. In FIG. 2, the thicknesses of layers are larger than actual thicknesses.

First, the configuration of the optical recording medium will be discussed below according to the present embodiment.

As shown in FIG. 2, in an optical recording medium 1 of the present embodiment, a first substrate 11A having a first groove G1A formed thereon, a first recording layer 21A formed on a first-groove forming surface of the first substrate 11A, a translucent first reflecting layer 31A, an intermediate layer 4A, a heat conducting layer 5A, a second recording layer 22A, a heat insulating layer 6A, a second reflecting layer 32A, and a second substrate 12A having a second groove G2A formed thereon are disposed in this order from the side where a laser beam for recording, reproduction, or recording/reproduction is applied. In other words, in the optical recording medium 1 of the present invention, the second recording layer 22A is sandwiched between the heat conducting layer 5A and the heat insulating layer 6A.

Moreover, according to the optical recording medium 1, even when a laser beam is applied from the side of the first substrate 11A to record information in the recording layers 21A and 22A in the grooves G1A and G2A, the second recording layer 22A and the second reflecting layer 32A are not in direct contact with each other, the second recording layer 22A is sandwiched between the heat conducting layer 5A and the heat insulating layer 6A as described above, and thus the first groove G1A and the second groove G2A (the first recording layer 21A and the second recording layer 22A) can have the same thermal behavior by performing control so that the heat conducting layer 5A has the same thermal property as the first reflecting layer 31A making contact with the first recording layer 21A and the heat insulating layer 6A has the same thermal property as the first substrate 11A making contact with the first recording layer 21A. Consequently, thermal deformation similar to that of the first groove G1A can be sufficiently made by a laser beam also on the second groove G2A, thereby achieving an equal signal amplitude in each of the recording layers.

The material of the heat conducting layer 5A in the optical recording medium 1 of the present invention is not particularly limited as long as the second groove G2A can have the same thermal behavior as the first groove G1A with the cooperation of the heat insulating layer 6A (described later). The material of the heat conducting layer 5A can be arbitrarily selected in balance with the heat insulating layer 6A. However, as described above, it is preferable that the heat conducting layer 5A has the same thermal property as the first reflecting layer 31A making contact with the first groove G1A and the heat insulating layer 6A (described later) has the same thermal property as the first substrate 11A making contact with the first groove G1A. Hence, for example, the heat conducting layer 5A is preferably made of the same material as the first reflecting layer 31A (described later) or such material as Al₂O₃ or AlN.

The thickness of the heat conducting layer 5A is not particularly limited as long as the foregoing effect is obtained. To be specific, a thickness of about 10 to 180 nm is preferable.

Like the heat conducting layer 5A, the material of the heat insulating layer 6A in the optical recording medium 1 of the present invention is not particularly limited as long as the second groove G2A can have the same thermal property as the first groove G1A with the cooperation of the heat conducting layer 5A. The material of the heat insulating layer 6A can be arbitrarily selected in balance with the heat conducting layer 5A. However, as described above, when the heat conducting layer 5A has the same thermal property as the first reflecting layer 31A making contact with the first groove G1A, it is preferable that the heat insulating layer 6A (described later) has the same thermal property as the first substrate 11A making contact with the first groove G1A. Hence, the heat insulating layer 6A is preferably made of the same material as the first substrate 11A (described later) or such material as ZnS and SiO₂.

The thickness of the heat insulating layer 6A is not particularly limited as long as the foregoing effect is obtained. To be specific, a thickness of about 10 to 180 nm is preferable.

Incidentally, the terms “heat conducting layer” and “heat insulating layer” in the present application are not used by the reason that the layer has actually certain extent of heat conducting or insulating property within specific range of coefficient of heat transmission, but are used metaphorically for expressing their roles as mentioned above.

The material of the first substrate 11A is a highly transparent resin, e.g., a resin having a light transmittance of 80% or higher for a laser beam for recording, reproduction, or recording/reproduction. A resin with a light transmittance of 90% or higher is more preferable. To be specific, for example, a polycarbonate resin, an acrylic resin such as polymethyl methacrylate, and a polyolefin resin are available. The material of the first substrate 11A is not limited to these resins.

The thickness of the first substrate 11A is normally 0.1 to 0.6 mm, which is determined according to the specification of the optical recording medium 1. That is, when the optical recording medium 1 is a DVD-R disc for a red laser, the first substrate 11A is 0.6 mm in thickness. When the optical recording medium 1 is a disc for a blue laser, the first substrate 11A is 0.6 mm or 0.1 mm in thickness. Besides, the first substrate 11A is a circular plate having a hole at the center.

The first groove is formed on a surface of the first substrate 11A, the surface having the first recording layer 21A formed thereon. The groove is normally about 100 to 180 nm in depth, about 0.25 to 0.35 μm in width, and about 0.7 to 0.9 μm in pitch.

The groove is shaped like a spiral or concentric circles, taken from the surface of the first substrate 11A. Further, the groove may meander in the radius direction at predetermined intervals. Hereinafter, such a meandering groove is referred to as a wobble groove. Furthermore, prepits carrying address information and so on may be formed at predetermined intervals on lands positioned between the grooves.

The material of the first recording layer 21A capable of optical recording is not particularly limited as long as the material is an organic dye used for the recording layer of the conventional optical recording medium. For example, a complex of an azo compound, cyanine dye, phthalocyanine dye, and so on are used. The first recording layer 21A normally has a thickness of 50 to 120 nm, which is not particularly limited.

The first reflecting layer 31A is made of metals including gold, aluminum, silver, copper and an alloy of these metals. The material of the first reflecting layer 31A is not limited to these metals. The first reflecting layer 31A normally has a thickness of about 10 to 20 nm, which is not particularly limited as long as semi-translucency is obtained, that is, a light beam for recording, reproduction, or recording/reproduction can be passed or reflected at a wavelength of the light.

The second substrate 12A is similar to the first substrate 11A in material, thickness, and shape.

The material of the second reflecting layer 32A is the same as the first reflecting layer 31A described above. However, unlike the first reflecting layer 31A, the material of the second reflecting layer 32A does not have to be semi-translucent. Further, the thickness of the second reflecting layer 32A is properly selected at, e.g., 50 nm within a range of the total reflection of a laser beam for recording/reproduction.

The second recording layer 22A capable of optical recording is similar to the first recording layer 21A in material, thickness, and shape.

The translucent intermediate layer 4A has a role to bond the first substrates 11A having the first groove G1A formed thereon on which a first recording layer 21A and a first reflecting layer 31A are laminated in this order, with the second substrates 12A having the second groove G2A formed thereon on which a second reflecting layer 32A, a heat insulating layer 6A and a second recording layer 22A are formed in this order along the second groove G2A and further a heat conducting layer 5A are laminated subsequently, with the first reflecting layer 31A and the second recording layer 22A facing each other. The material of the translucent intermediate layer 4A is not particularly limited and any material conventionally known to said bonding purpose can be used. For example, an ultraviolet curing resin is preferably used. The intermediate layer 4A normally has a thickness of about 40 μm, which is not particularly limited.

The layer structure of the optical recording medium 1 is not limited to that of FIG. 2. Other layers can be provided as appropriate as long as the foregoing layers are provided.

Further, in the optical recording medium 1 shown in FIG. 2, the first groove G1A and the second groove G2A are positioned in synchronization with each other (that is, overlaid on each other) in a direction orthogonal to the tracking direction. The arrangement of the first groove G1A of the first recording layer 21A and the second groove G2A of the second recording layer 22A is not limited to that of FIG. 2. The grooves may be positioned with a phase difference (that is, shifted from each other).

In the optical recording medium 1, a laser beam for recording or a laser beam for recording/reproduction is applied from the side of the first substrate 11A, and pits are formed on the first groove G1A of the first recording layer 21A, the lands of the first groove G1A, the second groove G2A of the second recording layer 22A, and the lands of the second groove G2A. Similarly a laser beam for reproduction or a laser beam for recording/reproduction is applied from the side of the first substrate 11A, and bit information formed on the first recording layer 21A and the second recording layer 22A is read.

The optical recording medium 1 can be a disc including a so-called DVD-R disc and a DVD-RW disc capable of recording and reproduction. Various kinds of recording mediums can be used according to a format, regardless of whether a record is erasable/rewritable or not and whether the recording medium is made of an organic dye other than the foregoing organic dyes.

As described above, according to the optical recording medium 1, even when a laser beam is applied from the side of the first substrate 11A to record information in the grooves G1A and G2A of the recording layers, the second groove G2A is sandwiched between the heat conducting layer 5A and the heat insulating layer 6A, and thus the first groove G1A and the second groove G2A can have the same thermal behavior by performing control so that the heat conducting layer 5A has the same thermal property as the first reflecting layer 31A making contact with the first groove G1A and the heat insulating layer 6A has the same thermal property as the first substrate 11A making contact with the first groove G1A. Consequently, thermal deformation can be sufficiently made by a laser beam also on the second groove G2A, thereby achieving equal signal amplitude in each recording layer.

The following will describe a method of manufacturing the optical recording medium 1 according to the present embodiment.

The optical recording medium 1 is manufactured as follows: on the first-groove forming surface formed on one side of the first substrate 11A, an organic dye making up the recording medium is laminated to form the first recording layer 21A, which is formed according to the shape of the groove, the first reflecting layer 31A is laminated on the first recording layer 21A, the second reflecting layer 32A is laminated in the meantime on a second-groove forming surface formed on one side of the second substrate 12A, the heat insulating layer 6A is laminated on the second reflecting layer 32A, an organic dye making up the recording medium is laminated on the heat insulating layer 6A to form the second recording layer 22A, which is formed according to the shape of the second groove, the heat conducting layer 5A is laminated on the second recording layer 22A, and the first reflecting layer 31A and the heat conducting layer 5A are bonded to each other via the transparent intermediate layer 4A.

The processes of the method will be described in detail below.

First, the first substrate 11A made of the above material with the above thickness is formed by injection molding of resin with a stamper. The first groove is formed in the above shape on one side of the first substrate 11A.

Subsequently, the first recording layer 21A made of the above material with the above thickness is formed on the first-groove forming surface of the first substrate 11A. The method of forming the first recording layer 21A is not particularly limited. Spin coating or the like is used in ordinary cases. To be specific, when the first recording layer 21A is formed by spin coating, the material of the first recording layer 21A is dissolved and dispersed into a solvent to prepare coating slip, and the coating slip is spin coated onto the first substrate 11A.

When the complex of an azo compound is used as the material of the first recording layer 21A, tetrafluoropropanol or octafluoropentanol is used as a solvent of the coating slip. Further, when the cyanine dye is used as the material of the first recording layer 21A, ethyl cellosolve or dimethylcyclohexane is used as the solvent of the coating slip.

Then, the first reflecting layer 31A made of the above material with the above thickness is formed on the first recording layer 21A. The method of forming the first reflecting layer 31A is not particularly limited. Sputtering, deposition, and so on are used in ordinary cases.

The second substrate 12A made of the above material with the above thickness is formed by injection molding of resin with a stamper. The second groove is formed in the above shape on one side of the second substrate 12A.

Subsequently, the second reflecting layer 32A made of the above material with the above thickness is formed thereon. The method of forming the second reflecting layer 32A is similar to the foregoing method.

Then, the heat insulating layer 6A made of the above material with the above thickness is laminated on the second reflecting layer 32A. The method of laminating the heat insulating layer 6A is not particularly limited. Sputtering, deposition, and so on can be used.

Subsequently, the second recording layer 22A made of the above material with the above thickness is formed on the heat insulating layer 6A. The method of forming the second recording layer 22A is similar to that of the first recording layer 21A.

Then, the heat conducting layer 5A made of the above material with the above thickness is laminated on the second recording layer 22A. The method of laminating the heat conducting layer 5A is not particularly limited. Sputtering, deposition, and so on can be used.

Finally, the first reflecting layer 31A and the heat conducting layer 5A are bonded to each other via the intermediate layer 4A. A conventionally known adhesive and so on can be used as the intermediate layer 4A.

In this way, the optical recording medium 1 of the present invention is manufactured.

According to the manufacturing method of the present embodiment, the optical recording medium 1 of the present invention can be readily formed with conventional processes and apparatus.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-345786 filed on Oct. 3, 2003 including the specification, claims, drawings and summary is incorporated herein by reference in its entirety.

1. An optical recording medium, in which a first substrate having a first groove formed thereon, a first recording layer formed on a first-groove forming surface of the first substrate, a semi-translucent first reflecting layer, an intermediate layer, a second recording layer, a second reflecting layer, and a second substrate having a second groove formed thereon are at least disposed in this order from the side where a laser beam for recording, reproduction, or recording/reproduction is applied,
the optical recording medium further comprising:
a heat conducting layer between the second recording layer and the intermediate layer, and
a heat insulating layer between the second recording layer and the second reflecting layer.

2. The optical recording medium according to claim 1, wherein the first and second recording layers are made of a dye material, the heat conducting layer is made of Al₂O₃ or AlN, and the heat insulating layer is made of ZnS and SiO₂.

3. A method of manufacturing an optical recording medium, comprising the steps of:
laminating a first recording layer made of a dye material and a semi-translucent first reflecting layer in this order on a first-groove forming surface of a first substrate,
laminating a second reflecting layer, a heat insulating layer, a second recording layer made of a dye material, and a heat conducting layer in this order on a second-groove forming surface of a second substrate, and
bonding the first and second substrates to each other via a transparent intermediate layer with the first reflecting layer and the heat conducting layer facing each other.
